(19) United States
(12) Patent Application Publication
(10) Pub. No.: US 2023/0316114 A1
(43) Pub. Date: Oct. 5, 2023

(54) DETECTION DEVICE, DETECTION METHOD, AND DETECTION PROGRAM

(71) Applicant: NIPPON TELEGRAPH AND TELEPHONE CORPORATION, Tokyo (JP)

(72) Inventors: Hiroyuki UEKAWA, Musashino-shi, Tokyo (JP); Eitaro SHIOJI, Musashino-shi, Tokyo (JP); Toshiki SHIBAHARA, Musashino-shi, Tokyo (JP); Mitsuaki AKIYAMA, Musashino-shi, Tokyo (JP)

(73) Assignee: NIPPON TELEGRAPH AND TELEPHONE CORPORATION, Tokyo (JP)

(21) Appl. No.: 18/024,778

(22) PCT Filed: Oct. 16, 2020
(86) PCT No.: PCT/JP2020/039193

§ 371 Date: Mar. 6, 2023

(51) Int. Cl. G06N 5/046

(52) U.S. Cl. CPC G06N 5/046

(57) ABSTRACT

A detection device (10) converts each of a plurality of pieces of information on a network to a logical equation. The detection device (10) obtains an answer set satisfying a logical equation and an inference rule through inference. It is possible to detect change in a network configuration on the basis of the answer set.

### TECHNICAL FIELD

The present invention relates to a detection device, a detection method, and a detection program.

### BACKGROUND ART

One information security service is a managed security service (MSS). MSS is a commercial service that is provided by a security operation center (SOC). For example, in the MSS, the SOC receives a security log from a customer and discovers security threats or the like hidden in the security log through advanced analysis.

In the analysis in the MSS, it is important to understand a network (NW) configuration of the customer. A method of actively scanning the NW in order to estimate an NW configuration is known, but the active scan may affect the NW.

Therefore, in the related art, a technology for estimating an NW configuration from passive information has been proposed. For example, a technology for estimating an NW configuration on the basis of information of an IP packet is known (see, for example, NPL 1). Further, for example, a technology for estimating an NW configuration on the basis of an event log is known (see, for example, NPL 2).

### CITATION LIST

### Non Patent Literature

[NPL 1] Eriksson, B., Barford, P. and Nowak, R. Network Discovery from Passive Measurements, Proc. SIGCOMM'08, pp. 291-302 (2008).
[NPL 2] Azodi, A., Cheng, F. and Meinel, C. Event Driven Network Topology Discovery and Inventory Listing Using REAMS, Wireless Personal Communications, Volume 94, Issue 3, pp. 415-430, DOI: 10.1007/s11277-0153061-3 (2017).

### SUMMARY OF INVENTION

### Technical Problem

However, the related art has the problem that it may be difficult to detect detailed change in an NW configuration within an organization from the passive information.

For example, the technology described in NPL 1 is an analysis technology for the Internet topology, and does not estimate the NW configuration in the organization. Further, for example, the technology described in NPL 2 performs estimation depending on an endpoint or a service, and may not be able to estimate a relationship between devices in detail.

### Solution to Problem

In order to solve the above-described problems and achieve the purpose, a detection device includes a conversion unit configured to convert each of a plurality of pieces of information on a network into an inference rule of a given format; and an inference unit configured to obtain an answer set satisfying both the inference rule of the given format and a preset inference rule through inference.

### Advantageous Effects of Invention

According to the present invention, it is possible to detect detailed change in an NW configuration within an organization from passive information.

### BRIEF DESCRIPTION OF DRAWINGS

FIG. 1 is a diagram illustrating an overview of a detection method according to a first embodiment.

FIG. 2 is a diagram illustrating an example of an NW configuration.

FIG. 3 is a diagram illustrating an example of an inference rule and an answer set.

FIG. 4 is a diagram illustrating a configuration example of a detection device according to the first embodiment.

FIG. 5 is a flowchart illustrating a flow of processing of the detection device according to the first embodiment.

FIG. 6 is a diagram illustrating an example of a computer that executes a detection program.

### DESCRIPTION OF EMBODIMENTS

Hereinafter, embodiments of a detection device, a detection method, and a detection program according to the present application will be described in detail with reference to the drawings. The present invention is not limited to the embodiments to be described below.

### First Embodiment

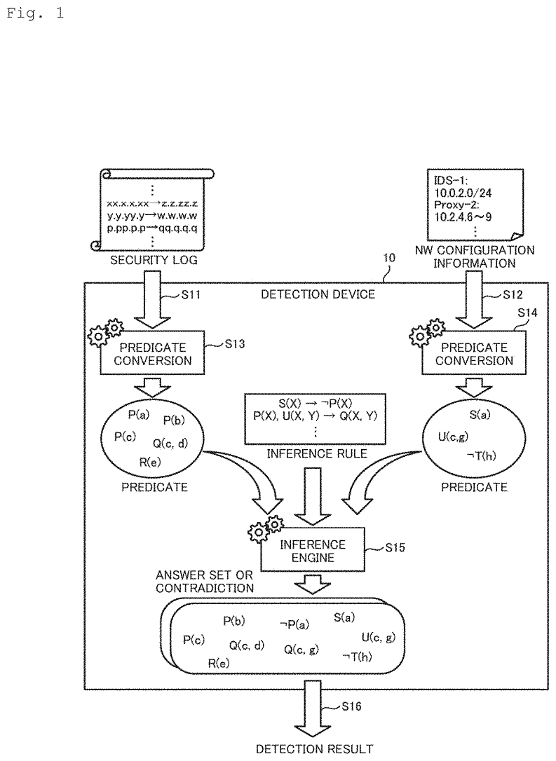

An overview of a detection method that is executed by a detection device will be described with reference to FIG. 1. FIG. 1 is a diagram illustrating an overview of the detection method according to a first embodiment.

As illustrated in FIG. 1, first, a detection device 10 receives an input of a security log (step S11). Further, the detection device 10 receives an input of NW configuration information (step S12). “Inference” in the embodiment is a term of logic and corresponds to reasoning.

Here, the security log is an example of information on an NW. A log, traffic data, or the like that is output by each NW device may be input to the detection device 10, instead of the security log.

Here, the detection device 10 performs predicate conversion on the security log and the NW configuration information (step S13 and step S14). The predicate conversion is a process that is performed in answer set programming (ASP), and is processing for converting predetermined information into a logical equation. Accordingly, the detection device 10 converts each of a plurality of pieces of information on the network into an inference rule of a predetermined format, that is, a fact.

References: clingo and gringo|Potassco, the Potsdam Answer Set Solving Collection, The University of Potsdam, available from <https://potassco.org/clingo/>

Then, the detection device 10 operates an inference engine on the basis of the predicate obtained by the predicate conversion and a preset inference rule (step S15). The inference engine is an engine for executing inference in answer set programming. That is, the detection device 10 obtains a fact obtained by the conversion, a preset derivation rule, and an answer set satisfying a constraint rule through inference.

The detection device 10 outputs a detection result based on the answer set obtained through inference (step S16). For example, when no answer set is obtained by the detection device 10, it can be considered that the security log and the NW configuration information differ. For example, an analyst can use this to detect a change in the NW configuration.

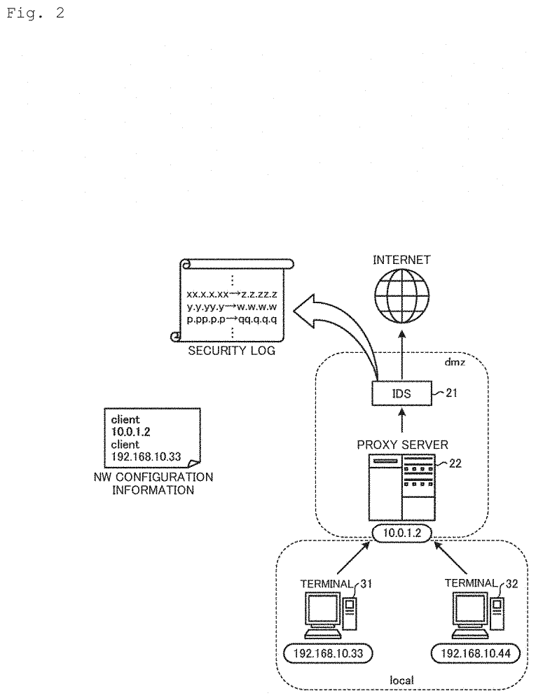

Here, an example of the NW configuration that is an inference target in the detection device 10 is illustrated in FIG. 2. FIG. 2 is a diagram illustrating an example of the NW configuration. As illustrated in FIG. 2, the NW includes an intrusion detection system (IDS) 21 connected to the Internet, a proxy server 22 connected to the IDS 21, and a terminal 31 and a terminal 32 connected to the proxy server 22.

The IDS 21 and the proxy server are disposed in a demilitarized zone (dnz). Further, the terminal 31 and the terminal 32 are disposed in local. “Local” means through a role area network constructed in an organization such as a company.

Further, it is assumed that the NW configuration information indicates that there are a client whose address is “10.0.1.2” and a client whose address is “192.168.10.33”. Here, the NW configuration information is, for example, information obtained from a customer by the analyst, and is not always accurate.

Here, it is assumed that the detection device 10 derives, through inference, a first predicate indicating that the address “10.0.1.2” is a proxy, and a second predicate indicating that the address “192.168.10.33” is a client, on the basis of the security log. As illustrated in FIG. 2, “10.0.1.2” is an address of the proxy server 22. Further, “192.168.10.33” is an address of the terminal 31.

The NW configuration information indicates that the address “192.168.10.33” is a client. This is not contradictory to the second predicate indicating that the address “192.168.10.33” is a client.

On the other hand, the NW configuration information indicates that the address “10.0.1.2” is a client. Therefore, the detection device 10 does not include the first predicate indicating that the address “10.0.1.2” is a proxy and the predicate indicating that the address “10.0.1.2” is a client in the answer set. Here, it is assumed that nodes being a client and a proxy is constrained according to a constraint rule, which is one of the inference rules. Details of a derivation rule and a constraint rule for deriving the predicate will be described below.

Further, for example, the analyst can detect the change in the NW configuration by referring to a result of inference of a plurality of security logs having different output dates and times in the detection device 10.

For example, it is assumed that the detection device 10 derives a third predicate indicating that the address “192.168.10.44” is a client on the basis of the security log at a certain point in time, and it is assumed that the detection device 10 derives a fourth predicate indicating that the address “192.168.10.44” is a proxy on the basis of the security log at a subsequent point in time. However, these derived predicates are not included in the answer set because the predicates are constrained according to a constraint rule.

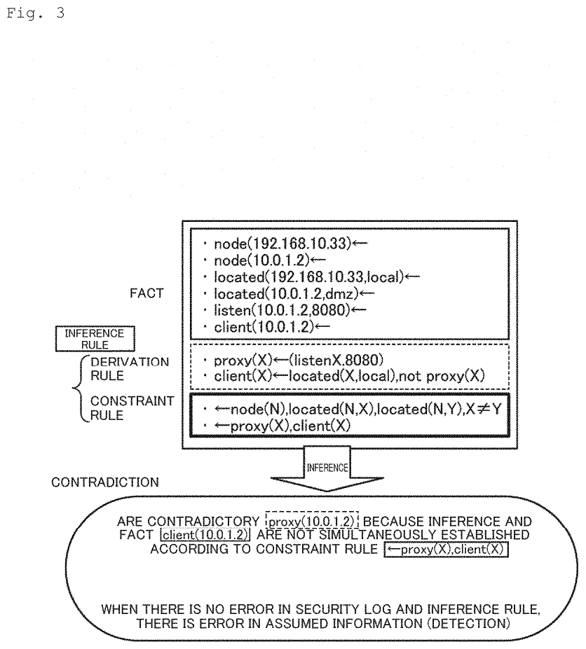

Here, the inference and the detection in the detection device 10 will be described in detail with reference to FIG. 3. FIG. 3 is a diagram illustrating an example of the inference rule and the answer set. A program is a set of rules in the answer set programming. Rules include facts and inference rules. Further, in the present embodiment, it is assumed that the inference rule includes a derivation rule and a constraint rule. In the following description, the program in the answer set programming may be simply referred to as a program.

Here, a body in the rule corresponds to a right part of a left arrow. Further, a head in the rule corresponds to a left portion of the left arrow. A literal is a positive or negative form of a predicate. A predicate prefixed with a symbol “¬” at the beginning is a negative literal.

The fact means that the body is empty, the head is a single literal-only rule, and the head is true without any premise. For example, a predicate “node (10.0.1.2)” means that “10.0.1.2 exists as a node”. Therefore, the fact “node (10.0.1.2)←” in FIG. 3 means that ““10.0.1.2 exists as a node” is unconditionally correct”.

A predicate “located (192.168.10.33, local)” in FIG. 3 means that “192.168.10.33 exists locally”. Further, the predicate “located (10.0.1.2, dmz)” means “10.0.1.2 exists in the dmz”. Further, the predicate “listen (10.0.1.2,8080)” means “10.0.1.2 is receiving on port 8080”.

Further, a predicate “client (10.0.1.2)” means “10.0.1.2 is a client”. Therefore, a fact “client (10.0.1.2)←” in FIG. 3 means that ““10.0.1.2 is a client” is unconditionally correct.”

The fact is obtained by the detection device 10 converting information on the NW, such as a security log. For example, as illustrated in FIG. 3, the detection device 10 converts at least one of information on an address existing as a node, information indicating an area on a network on which the address exists, and information in which an address is associated with a listening port to a predicate.

For example, a conversion unit 131 converts the information on the address existing as a node to obtain a predicate node. Further, for example, the conversion unit 131 converts the information indicating the area on the network in which the address exists, to obtain a predicate located. Further, for example, the conversion unit 131 converts the information in which an address is associated with a listening port to obtain a predicate listen.

The derivation rule is an inference rule for deriving a predicate. The derivation rule is an example of a first inference rule. For example, a derivation rule “proxy (X)←listen (X, 8080)” in FIG. 3 means that “X received on port 8080 is a proxy”.

For example, the detection device 10 applies a derivation rule “proxy (X)←listen (X, 8080)” to a fact “listen (10.0.1.2,8080)←” to derive a predicate “proxy (10.0.1.2)”. Further, for example, the detection device 10 can apply a derivation rule “client (X)←located (X, local), not proxy (X)” to a fact “located (192.168.10.33, local)←” or the like to derive a predicate “client (192.168.10.33)”.

Thus, the detection device 10 derives a combination of predicates, as a candidate for the answer set, from the predicates obtained by converting the information on the NW, according to the derivation rule. Further, the derivation rule is not limited to an antecedent affirmative type derivation rule illustrated in FIG. 3, and may be a consequent negative type derivation rule that performs contraposition inference. Further, a predicate of a head of the derivation rule is a candidate for the predicate included in the answer set.

Further, the constraint rule is an inference rule as a constraint. The constraint rule is an example of a second inference rule. According to the constraint rule, a contradiction can be explicitly derived as an inference result.

Here, a constraint rule “←node (N), located (N, X), located (N, Y), X≠Y” illustrated in FIG. 3 means that “a node N exists in regions X and Y different from each other.” A predicate constrained according to the inference rule is a predicate that satisfies a body of the constraint rule. On the other hand, a predicate that is not constrained according to the inference rule is a predicate that does not satisfy the body of the constraint rule.

For example, in the example of FIG. 3, the detection device 10 obtains a set of predicates including a predicate “node (192.168.10.33)” and the predicate “node (10.0.1.2)” as candidates for the answer set on the basis of the constraint rule “←node (N), located (N, X), located (N, Y), X≠Y.”

When there are both the fact “located (192.168.10.33, local)←” and a fact “located (192.168.10.33,dmz)←” exist, the detection device 10 excludes a combination of predicates including the predicate “node (192.168.10.33)”, the predicate “located (192.168.10.33,local)”, and a predicate “located (192.168.10.33,dmz)”)←” from the candidates for the answer set as a contradictory combination on the basis of the constraint rule “←node (N), located (N, X), located (N, Y), X≠Y”, and outputs that the inference result is unsatisfactory when there is no other answer set.

Thus, the detection device 10 excludes the combination of predicates constrained according to the constraint rule from the answer set derived according to the derivation rule. Further, the predicate that is the candidate for the answer set is a predicate that is not constrained according to at least one constraint rule, and may be excluded from a final answer set by combining a plurality of constraint rules.

Here, when the fact “client (10.0.1.2)←” is obtained from the NW configuration information, the detection device 10 sets the predicate “client (10.0.1.2)” as a candidate for the predicate to be included in the answer set. Further, when the fact “listen (10.0.1.2,8080)←” is obtained from the security log, the detection device 10 derives the predicate “proxy (10.0.1.2)” as a candidate for the predicate to be included in the answer set.

Further, a constraint rule “←proxy (X), client (X)” means that “X cannot be both a proxy and a client”. Therefore, it can be said that the predicate “client (10.0.1.2)” and the predicate “proxy (10.0.1.2)” are contradictory on the basis of the constraint rule “←proxy (X), client (X)”. Thus, the detection device 10 can detect the contradiction by applying the constraint rule in the combination of the two predicates.

The answer set is a set of predicates inferred to be contradictory by the detection device 10. Further, the answer set can be said to be an output of the program in the answer set programming. Further, the answer set can be said to be a combination of predicates that satisfy facts and inference rules. Strictly speaking, the combination of predicates that can be the answer set theoretically satisfies certain properties. For example, predicates that may or may not be present are not included in the answer set.

There are a case in which a plurality of answer sets can be obtained for one program, and a case in which no answer set can be obtained (no solution). For example, when there is no predicate derived from the fact on the basis of the derivation rule, and all the facts are considered to be contradictory on the basis of the constraint rule, no answer set can be obtained.

### Configuration of First Embodiment

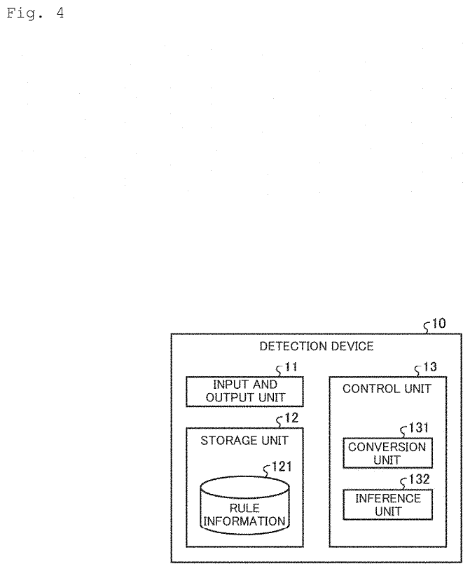

A configuration of the detection device according to the first embodiment will be described with reference to FIG. 4. FIG. 4 is a diagram illustrating a configuration example of the detection device according to the first embodiment. The detection device 10 receives an input of the information on the NW, such as a security log, performs an inference, and outputs the inference result. As illustrated in FIG. 1, the detection device 10 includes an input and output unit 11, a storage unit 12, and a control unit 13.

The input and output unit 11 is an interface for performing input and output of data. For example, the input and output unit 11 may be a communication interface such as a network interface card (NIC) for performing data communication with another device via a network. Further, the input and output unit 11 may be an interface for connecting an input device such as a mouse and a keyboard, and an output device such as a display.

The storage unit 12 is a storage device for a hard disk drive (HDD), a solid state drive (SSD), or an optical disc. The storage unit 12 may be a data rewritable semiconductor memory, such as a random access memory (RAM), a flash memory, or a non-volatile static random access memory (NVSRAM). The storage unit 12 stores an operating system (OS) or various programs that are executed by the detection device 10.

The storage unit 12 stores rule information 121. The rule information 121 is an inference rule including a derivation rule and a constraint rule.

The control unit 13 controls the entire detection device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA). Further, the control unit 13 includes an internal memory for storing a program or control data that defines various processing procedures, and executes each processing using an internal memory. Further, the control unit 13 functions as various processing units by operating various programs. For example, the control unit 13 includes the conversion unit 131, an inference unit 132, and a detection unit 133.

The conversion unit 131 converts each of the plurality of pieces of information on the network into a predetermined format of inference rule, that is, a fact. For example, the conversion unit 131 converts the information on the network into a predicate of answer set programming. Further, for example, the conversion unit 131 converts at least one of the information on an address existing as a node, the information indicating an area on a network on which the address exists, and the information in which an address is associated with a listening port to a fact.

The inference unit 132 obtains a combination of predicates satisfying a program consisting of facts and preset inference rules through inference. For example, the inference unit 132 obtains the predicate derived according to the inference rule (for example, a derivation rule) from the predicates obtained by the conversion unit 131 as a candidate for a predicate to be included in the answer set. Further, for example, the inference unit 132 obtains, as an answer set, a combination of predicates that is not contradictory to the inference rule (for example, the constraint rule) among the predicates obtained by the conversion unit 131 and the predicates derived by the inference unit 132.

In the example of FIG. 3, the fact “client (10.0.1.2)←” is an example of a predetermined format of inference rule. The fact “listen (10.0.1.2,8080)←” is an example of a preset inference rule. Further, “client (10.0.1.2)” and “proxy (10.0.1.2)” are examples of predicates derived on the basis of the first inference rule (derivation rule). However, these predicates may be excluded from a final output answer set on the basis of the second inference rule (constraint rule).

(Example of Inference Rule)

In addition to those illustrated in FIG. 3 and the like, the detection device 10 can use the inference rules as illustrated in the following (1) to (5). (1) to (5) are examples of derivation rules for deriving whether or not a node is a proxy.
(1) proxy (X)←tcp_dest (X, 8080), not¬proxy (X)
(2) proxy (X)←tcp_dest (X, 8000), not¬proxy (X)
(3) proxy (X)←has_xff_header (X)
(4) proxy (YA)←http_req (XA, XP, YA, YP, URL), http_req (YA, YP′, ZA, ZP, URL)
(5)¬proxy (X)←in_global (X)

Because “not” means that it is not true (it cannot be confirmed that it is true), for example, (1) means that “it cannot be confirmed that a destination of TCP communication is port 8080 of X and X is not a proxy”, X is a proxy.”

Respective arguments of http_req correspond to a transmission source address, a transmission source port, a destination address, a destination port, and a URL of an HTTP request from the left. That is, (4) means, “when a transmission source address of a first HTTP request and a destination address YA of a second HTTP request match and URLs of both match, YA is likely to be a proxy.” However, regarding (4), other conditions may be required for arguments other than YA, such as XA and XP.

has_xff_header (X) means that the X-Forwarded-For header is added to the HTTP request transmitted by X. Further, in_global (X) means that node X exists on a global area network.

### Processing of First Embodiment

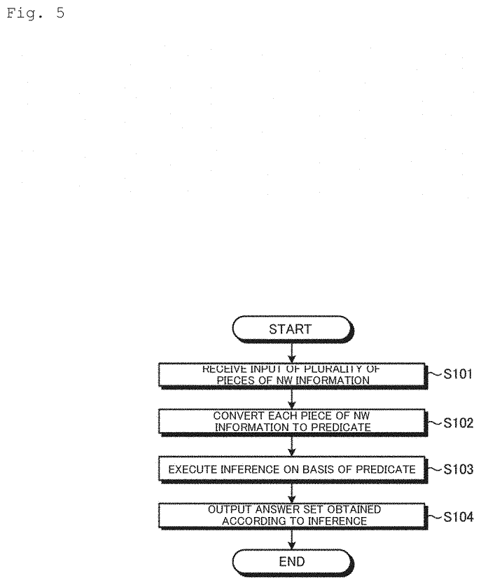

FIG. 5 is a flowchart illustrating a flow of processing of the detection device according to the first embodiment. First, the detection device 10 receives an input of a plurality of pieces of NW information (step S101). Then, the detection device 10 converts each piece of NW information to a predicate (step S102).

For example, the plurality of pieces of NW information may be NW configuration information and a security log, or may be a plurality of security logs having different output dates and times.

Here, the detection device 10 executes inference based on the predicates (step S103). For example, the detection device 10 derives a predicate from the fact on the basis of a derivation rule, and obtains a combination of predicates as the candidate for the answer set. Further, for example, the detection device 10 excludes the candidates for the answer set including a combination of contradictory predicates on the basis of the constraint rule.

the detection device 10 outputs the answer set obtained through inference (step S104). For example, the analyst can detect the change in NW configuration by referring to the output answer set. For example, when no answer set is output, the analyst detects that the NW configuration has changed.

### Effects of First Embodiment

As described above, the conversion unit 131 converts the information on the network into the predetermined format of inference rule (fact). The inference unit 132 obtains an answer set satisfying the predetermined format of inference rule (fact) and the preset inference rule (a derivation rule and a constraint rule) through inference. Thus, because the detection device 10 converts the information on the network into an inference rule, it is possible to obtain the information on the network configuration from different information using a logical inference scheme. As a result, according to the present embodiment, it is possible to ascertain detailed change in the NW configuration within the organization from passive information.

Here, when an MSS is implemented, the analyst may not be able to obtain a detailed NW diagram or the like because the NW configuration is not accurately ascertained on the customer side and the NW configuration is confidential. In such a case, according to the present embodiment, the analyst can also detect an error in the NW diagram from limited available information such as a security log.

Further, there may be problems such as an error being in the description, change being not reflected, information necessary for analysis being not described, or more information than necessary being described in the obtained information. In such a case, according to the present embodiment, the analyst can also ascertain an NW configuration with a required particle size by setting an appropriate inference rule.

The conversion unit 131 converts the information on the network into the predicate of the answer set programming. The inference unit 132 derives a predicate to be included in the answer set from the predicates obtained by the conversion unit 131 according to the derivation rule, and obtains a combination of predicates as the candidate for the answer set. This makes it possible for the detection device 10 to derive information that is not clearly included in the fact.

The inference unit 132 excludes the combination of predicates constrained according to the constraint rule from the candidates for the answer set derived according to the derivation rule. This makes it possible for the detection device 10 to exclude combinations that are contradictory to an actual NW configuration included in the fact.

The inference unit 132 may exclude the combination of predicates according to an implicit constraint rule, in addition to an explicitly set constraint rule. In this case, for example, the inference unit 132 excludes a combination of contradictory predicates such as proxy (a) and ¬proxy (a).

The conversion unit 131 converts at least one of the information on an address existing as a node, the information indicating an area on a network on which the address exists, and the information in which an address is associated with a listening port to a fact. The makes it possible for the detection device 10 to detect change in role from the client to the proxy or from the proxy to the client.

[System Configuration, or the Like]

Further, each component of each illustrated device is a functional conceptual component and does not necessarily need to be physically configured as illustrated in the drawings. That is, a specific form of distribution and integration of the respective devices is not limited to the form illustrated in the drawings, and all or some of the devices can be distributed or integrated functionally or physically in any units according to various loads, and use situations. Further, all or some of processing functions to be performed in each device can be realized by a CPU and a program analyzed and executed by the CPU, or can be realized as hardware using a wired logic. The program may be executed not only by the CPU but also by another processor such as a GPU.

Further, all or some of the processing described as being performed automatically among the processing described in the present embodiment can be performed manually, and alternatively, all or some of the processing described as being performed manually can be performed automatically using a known method. In addition, information including the processing procedures, control procedures, specific names, and various types of data or parameters illustrated in the above literature or drawings can be arbitrarily changed unless otherwise described.

[Program]

As an embodiment, the detection device 10 can be implemented by installing a detection program for executing the detection processing in a desired computer as packaged software or on-line software. For example, it is possible to cause an information processing device to function as the detection device 10 by causing the information processing device to execute the detection program. Here, the information processing device includes a desktop or laptop personal computer. Further, a mobile communication terminal such as a smart phone, a mobile phone, or a personal handyphone system (PHS), or a slate terminal such as a personal digital assistant (PDA), for example, is included in a category of the information processing device.

Further, the detection device 10 can be implemented as a detection server device that provides a service regarding the above detection processing to a client, which is a terminal device used by a user. For example, the inference server device is implemented as a server device that provides a detection service that receives the security log as an input and outputs the detection result. In this case, the detection server device may be implemented as a web server, or may be implemented as a cloud that provides a service regarding the above detection processing through outsourcing.

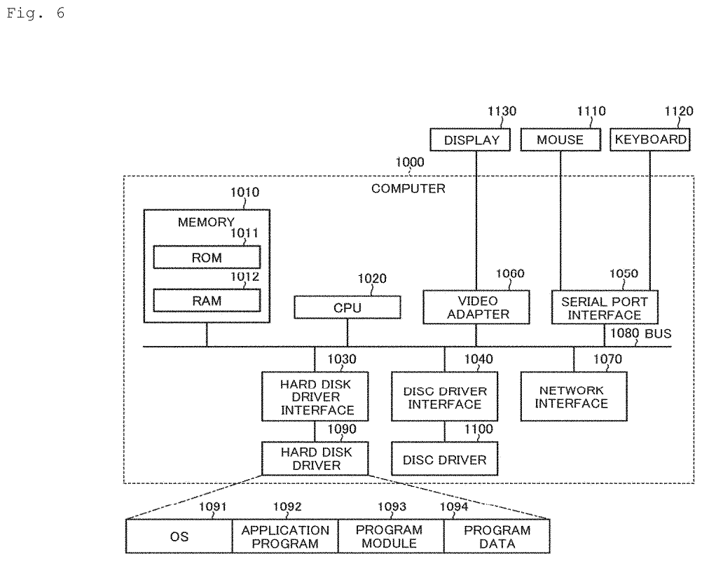

FIG. 6 is a diagram illustrating an example of a computer that executes a detection program. The computer 1000 includes, for example, a memory 1010 and a CPU 1020. Further, the computer 1000 includes a hard disk drive interface 1030, a disc drive interface 1040, a serial port interface 1050, a video adapter 1060, and a network interface 1070.

The respective units are connected by a bus 1080.

The memory 1010 includes a read only memory (ROM) 1011 and a random access memory (RAM) 1012. The ROM 1011 stores, for example, a boot program such as a Basic Input Output System (BIOS). The hard disk drive interface 1030 is connected to a hard disk drive 1090. The disc drive interface 1040 is connected to a disc drive 1100. For example, a removable storage medium such as a magnetic disk or an optical disc is inserted into the disc drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining each processing of the detection device 10 is implemented as the program module 1093 in which a code that can be executed by the computer has been described. The program module 1093 is stored in, for example, the hard disk drive 1090. For example, the program module 1093 for executing the same processing as a functional configuration in the detection device 10 is stored in the hard disk drive 1090. The hard disk drive 1090 may be replaced with a solid state drive (SSD).

Further, configuration data to be used in the processing of the embodiment described above is stored as the program data 1094 in, for example, the memory 1010 or the hard disk drive 1090. The CPU 1020 reads the program module 1093 or the program data 1094 stored in the memory 1010 or the hard disk drive 1090 into the RAM 1012 as necessary, and executes the processing of the above-described embodiment.

The program module 1093 or the program data 1094 is not limited to being stored in the hard disk drive 1090, and may be stored, for example, in a detachable storage medium and read by the CPU 1020 via the disc drive 1100 or the like. Alternatively, the program module 1093 and the program data 1094 may be stored in another computer connected via a network (a local area network (LAN), a wide area network (WAN), or the like). The program module 1093 and the program data 1094 may be read from another computer via the network interface 1070 by the CPU 1020.

### REFERENCE SIGNS LIST

10 Detection device
11 Input and output unit
12 storage unit
13 Control unit
121 Rule information
131 Conversion unit
132 Estimation unit

1. A detection device, comprising:
conversion circuitry configured to convert each of a plurality of pieces of information on a network into an inference rule of a given format; and
inference circuitry configured to obtain an answer set satisfying both the inference rule of the given format and a preset inference rule through inference.

2. The detection device according to claim 1, wherein:
the conversion circuitry converts the information on the network to a predicate of answer set programming, and
the inference circuitry derives a combination of predicates as a candidate for the answer set from the predicate obtained by the conversion circuitry according to a first inference rule.

3. The detection device according to claim 2, wherein:
the inference circuitry excludes a combination of predicates constrained according to a second inference rule from the candidate for the answer set derived according to the first inference rule.

4. The detection device according to claim 1, wherein:
the conversion circuitry converts at least one of information on an address existing as a node, information indicating an area on a network on which the address exists, and information in which an address is associated with a listening port to a logical equation.

5. A detection method, comprising:
converting each of a plurality of pieces of information on a network into an inference rule of a given format; and
obtaining an answer set satisfying both the inference rule of the given format and a preset inference rule through inference.

6. A non-transitory computer readable medium storing a detection program for causing a computer to function as the detection device according to claim 1.

7. A non-transitory computer readable medium storing a detection program for causing a computer to perform the method of claim 5.

8. The method of claim 5, wherein:
the converting converts the information on the network to a predicate of answer set programming, and
the obtaining derives a combination of predicates as a candidate for the answer set from the predicate obtained by the converting according to a first inference rule.

9. The method of claim 8, wherein:
the obtaining excludes a combination of predicates constrained according to a second inference rule from the candidate for the answer set derived according to the first inference rule.

10. The method of claim 5, wherein:
the converting converts at least one of information on an address existing as a node, information indicating an area on a network on which the address exists, and information in which an address is associated with a listening port to a logical equation.
